(19) United States
(12) Patent Application Publication
(10) Pub. No.: US 2007/0153078 A1
(43) Pub. Date: Jul. 5, 2007

(54) Cartridges For Reprographics Devices

(75) Inventor: Russell Paul Cowburn, London (GB)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: INGENIA HOLDINGS (UK) LIMITED, London (GB)

(21) Appl. No.: 11/614,117

(22) Filed: Dec. 21, 2006

Related U.S. Application Data
(60) Provisional application No. 60/753,685, filed on Dec. 23, 2005.

(30) Foreign Application Priority Data
Dec. 23, 2005 (GB) GB 0526420.5

(51) Int. Cl. B41J 2/385

(52) U.S. Cl. 347/133

(57) ABSTRACT

A removable cartridge for a reprographics device, such as a printer, is described. The removable cartridge comprises a signature scanning unit for use in generating a signature based upon an intrinsic characteristic of an article, such as a paper sheet, determined by illuminating the article with a coherent beam. By providing a signature scanning unit in a replaceable cartridge, few or no modifications to the existing designs of various reprographics devices are needed. Additionally, the installation of the signature scanning unit in a reprographics device is made as easy as replacing a standard removable cartridge, such as, for example, an inkjet or toner cartridge. The addition of authorisation/identification functionality to various conventional reprographics devices can also be made by a non-technical user using various embodiments of the invention.

### RELATED APPLICATIONS

This application claims priority to and incorporates by reference U.S. provisional application No. 60/753,685 filed on Dec. 23, 2005 and Great Britain patent application number GB 0526420.5 filed on Dec. 23, 2005.

### FIELD

The present invention relates to removable cartridges for reprographics devices. In particular, it relates to removable cartridges that can be used in the process of identifying articles that may be used with reprographics devices. In one example, the reprographics device is a printer and the article is a sheet of paper that is passed through the printer.

The accurate and secure identification of various articles is known to be difficult. This is particularly so for articles that are produced with the aid of modern reprographics devices. Such articles may, for example, be produced either as individual “one-off” items (e.g. a passport, personal identification (ID) card, bill of lading, important document etc.) or in batches (e.g. postage stamps, limited edition prints, vendable products etc.) using, for example, reprographics devices such as printers, photocopiers, etc. Improvements in technology relating to reprographics devices have made it very much easier for forgers and counterfeiters to produce high quality copies of such articles.

To counter copying of various articles, many traditional authentication security systems rely on a process which is difficult for anybody other than the manufacturer to perform, where the difficulty may be imposed by expense of capital equipment, complexity of technical know-how or preferably both. Examples are the provision of a watermark in bank notes and a hologram on credit cards or passports. Unfortunately, criminals are becoming more sophisticated and can reproduce virtually anything that original manufacturers can do, particularly given continual rapidly advancing improvements in technology relating to reprographics devices, as referred to previously.

Because of this, there is a known approach to authentication security systems which relies on creating security tokens using some process governed by laws of nature which results in each token being unique, and more importantly having a unique characteristic that is measurable and can thus be used as a basis for subsequent verification. According to this approach tokens are manufactured and measured in a set way to obtain a unique characteristic. The characteristic can then be stored in a computer database, or otherwise retained. Tokens of this type can be embedded in the carrier article, e.g. a banknote, passport, ID card, important document. Subsequently, the carrier article can be measured again and the measured characteristic compared with the characteristics stored in the database to establish if there is a match.

Moreover, whilst conventional security tokens can be used to access information, authorise transactions etc., damaged tokens and imperfect token identification apparatuses can lead to difficulties in carrying out the activities to which the token should provide enablement.

The inventors have previously adopted various approaches when seeking to address various of the problems and disadvantages referred to above.

In one, the inventors applied a technique of using tokens made of magnetic materials for authentication, where the uniqueness is provided by unreproducible defects in the magnetic material that affect the token's magnetic response (as detailed in PCT/GB03/03917, Cowburn). As part of this work, magnetic materials were fabricated in barcode format, i.e. as a number of parallel strips. As well as reading the unique magnetic response of the strips by sweeping a magnetic field with a magnetic reader, an optical scanner was built to read the barcodes by scanning a laser beam over the barcode and using contrast from the varying reflectivity of the barcode strips and the article on which they were formed. This information was complementary to the magnetic characteristic, since the barcode was being used to encode a digital signature of the unique magnetic response in a type of well known self authentication scheme, for example as also described above for banknotes (see for example, Kravolec “Plastic tag makes foolproof ID”, Technology research news, 2 Oct. 2002).

To the surprise of the inventor, it was discovered when using this optical scanner that the paper background material on which the magnetic chips were supported gave a unique optical response to the scanner. On further investigation, it was established that many other unprepared surfaces, such as surfaces of various types of cardboard and plastic, show the same effect. Moreover, it has been established by the inventor that the unique characteristic arises at least in part from speckle, but also includes non-speckle contributions.

It has thus been discovered that it is possible to gain all the advantages of speckle based techniques without having to use a specially prepared token or specially prepare an article in any other way. In particular, many types of paper, cardboard and plastics have been found to give unique characteristic scattering signals from a coherent light beam, so that unique digital signatures can be obtained from almost any paper document or cardboard packaging item.

In contrast, previously known speckle readers used for security devices appear to be based on illuminating the whole of a token with a laser beam and imaging a significant solid angle portion of the resultant speckle pattern with a CCD (see for example GB 2 221 870 and U.S. Pat. No. 6,584,214), thereby obtaining a speckle pattern image of the token made up of a large array of data points.

Problems can also arise when trying to make practical use of various of the authorisation/identification techniques mentioned above. For example, speckle-based readers add to the complexity, size and cost of reprographic devices in which they might be incorporated, and this in turn dissuades their general acceptance as an industry standard reader, despite their technical superiority for use as an identification tool compared with conventional techniques.

### SUMMARY

The present invention has been made, at least in part, in consideration of problems and drawbacks referred to herein.

Viewed from a first aspect, the present invention provides a removable cartridge for a reprographics device. The removable cartridge comprises a signature scanning unit for use in generating a signature based upon an intrinsic characteristic of an article. The signature scanning unit also comprises a reading volume for receiving an article when the reprographics device is in operation, a source for generating a coherent beam, and a detector arrangement for collecting a set comprising groups of data points from signals obtained when the coherent beam scatters from different parts of an article in the reading volume. Different ones of the groups of data points relate to scatter from respective different parts of the article.

By providing a signature scanning unit in a replaceable cartridge, few or no modifications to the existing designs of various reprographics devices are needed. Additionally, the installation of the signature scanning unit in a reprographics device is made as easy as replacing a standard removable cartridge, such as, for example, an inkjet or toner cartridge. The addition of authorisation/identification functionality to various conventional reprographics devices can thus be retrofitted by a non-technical user using various embodiments of the invention.

In various embodiments, the detector arrangement comprises a plurality of photodetectors. Each photodetector being for detecting a respective signal obtained when the coherent beam scatters from different parts of the article in the reading volume. By using such a plurality of photodetectors, a larger number of unique articles can be recognised using a faster and more accurate recognition process. However, where a simplified low-cost signature scanning unit is needed, a single photodetectors may be provided in the detector arrangement and still be operable to obtain sufficient data points to enable a signature to be determined.

Various embodiments include a data acquisition and processing unit in the removable cartridge for determining a signature of the article based upon an intrinsic property of the article from the set of groups of data points. This enables a single removable cartridge to generate the data points and analyse them to determine the signature without relying on processing provided externally of the cartridge. Such cartridges simplify the design of the reprographics device and are easy to use. Once determined, the signature itself can be transmitted over an existing communications channel from the cartridge to a device external to the cartridge (e.g. using a conventional “out of toner/ink” channel) or via one or more alternative channels (e.g. such as via a radio transmitter, like a Bluetooth™ enabled device, provided in the cartridge).

Other embodiments may require that the signature be derived by processing of the data points remotely from the cartridge. For example, values corresponding to the data points may be transmitted to a processor provided in the reprographics device, or to a processor provided remotely from the reprographics device. For example, processing may be undertaken by a printer processor or external processor (such as a personal computer (PC) processor) connected to a printer. In such embodiments, modified driver software may be provided in the cartridge and/or the reprographics device and/or the external processor.

In various examples, the removable cartridge is configured to substitute for a removable printer cartridge in a printer. The removable printer cartridge may be an inkjet printer cartridge. For example, the inkjet printer cartridge may be a colour inkjet cartridge. In this latter case, the signature scanning unit might be operated by sending signals to the printer corresponding to coloured dots. For example, a signal instructing the printer to print a red dot might be used to instruct the cartridge to begin a scan to acquire the data points, and a signal instructing the printer to print a green dot might be used to instruct the cartridge to stop acquiring the data points and either determine the signature or begin transmission of the data point data for processing. Such a cartridge can thus use existing software drivers to scan for a signature without requiring an extensive rewrite of the driver software.

In certain embodiments, the removable cartridge can also be operable to print on an article when the printer is operated. Such embodiments may be made by modifying conventional printer cartridges by adding a source/detector arrangement to provide additional signature scanning functionality.

Viewed from a second aspect, the present invention provides a reprographics device adapted to operate with the removable cartridge according to the first aspect of the present invention. For example, a conventional reprographics device, such as a printer, may be modified to accommodate the removable cartridge having a signature scanning unit.

Viewed from a third aspect, the present invention provides a system for identifying an article from a signature based upon an intrinsic characteristic of the article. The system comprises a signature determination unit comprising a removable cartridge according to the first aspect of the present invention, and a comparison unit operable to compare the determined signature to a stored signature. Such a system may operate in various modes, to identify and/or initially acquire signatures from various articles. For example, such a system may be operated to determine signatures and then to store them for use in subsequently identifying articles. Signatures may, for example, be stored in a database, which might be coupled to a networked system for access by multiple reprographics device hosts.

In various embodiments of the system, the comparison unit is further operable to split the determined signature into blocks of contiguous data and to perform a comparison operation between each block and respective blocks of the stored signature. Such a so-called “block-wise” analysis enables articles that are damaged (e.g. by stretching or shrinking) to be reliably identified. It also enables the constraints otherwise imposed upon the physical alignment between the article and the signature scanning unit to be relaxed while still providing an acceptable level of signature identification accuracy for the articles.

Viewed from a fourth aspect, the present invention provides a method for identifying an article from a signature based upon an intrinsic characteristic of the article. The method comprises determining a signature from data points generated by operating a signature scanning unit provided in a removable cartridge of a reprographics device, and comparing the determined signature to a stored signature. The method may also comprise splitting the determined signature into blocks of contiguous data, and performing a comparison operation between each block and respective blocks of the stored signature.

Viewed from a fifth aspect, the present invention provides a computer program product for controlling the operation of the removable cartridge according to the first aspect of the present invention. The computer program product comprises code that is executable to control activation of the coherent source of the signature scanning unit and collection of the set comprising groups of data points by the detector arrangement. The computer program product may also comprise code that is executable to manage the transfer of the set comprising groups of data points from the cartridge to a processing unit located external to the removable cartridge. For example, a driver (e.g. acting as a PC/printer interface) may be provided that allows the external processing unit (e.g. the PC) to do any signature determination processing, thereby avoiding the need to provided extra hardware in the cartridge thus making the cartridge cheaper to manufacture and possibly also more reliable.

### BRIEF DESCRIPTION OF THE FIGURES

Specific embodiments of the present invention will now be described by way of example only with reference to the accompanying figures in which:

FIG. 1 is a schematic view of a system for identifying an article from a signature based upon an intrinsic characteristic of the article;

FIG. 2 is a schematic view of a removable cartridge for a reprographics device in operation;

FIG. 3 is a schematic side view of an example of a scanning signature unit;

FIG. 4 is a schematic perspective view showing how the reading volume of the scanning signature unit of FIG. 3 is sampled;

FIG. 5 is a block schematic diagram of various functional components of the system of FIG. 1;

FIG. 6 is a schematic view of a reprographics device incorporating a scanning signature unit;

FIG. 7 is a schematic view of another example of a reprographics device incorporating a scanning signature unit;

FIG. 8A shows schematically in side view an alternative imaging arrangement for a scanning signature unit based on directional light collection and blanket illumination;

FIG. 8B shows schematically in plan view the optical footprint of a further alternative imaging arrangement for a scanning signature unit in which directional detectors are used in combination with localised illumination with an elongate beam;

FIG. 9A is a microscope image of a paper surface with the image covering an area of approximately 0.5×0.2 mm;

FIG. 9B is a microscope image of a plastic surface with the image covering an area of approximately 0.02×0.02 mm;

FIG. 10A shows raw data from a single photodetector using the scanning signature unit of FIG. 3 which consists of a photodetector signal and an encoder signal;

FIG. 10B shows the photodetector data of FIG. 10A after linearisation with the encoder signal and averaging the amplitude;

FIG. 10C shows the data of FIG. 10B after digitisation according to the average level;

FIG. 11 is a flow diagram showing how a signature of an article is generated from a scan;

FIG. 12 is a flow diagram showing how a signature of an article obtained from a scan can be verified against a signature database;

FIG. 13 is a flow diagram showing how the verification process of FIG. 12 can be altered to account for non-idealities in a scan;

FIG. 14A shows an example of cross-correlation data gathered from a scan;

FIG. 14B shows an example of cross-correlation data gathered from a scan where the scanned article is distorted;

FIG. 14C shows an example of cross-correlation data gathered from a scan where the scanned article is scanned at non-linear speed;

FIG. 15 is a schematic cut-away perspective view of a multi-scan scanning signature unit; and

FIG. 16 is a schematic cut-away perspective view of a multi-scan scanning signature unit.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DESCRIPTION OF PARTICULAR EMBODIMENTS

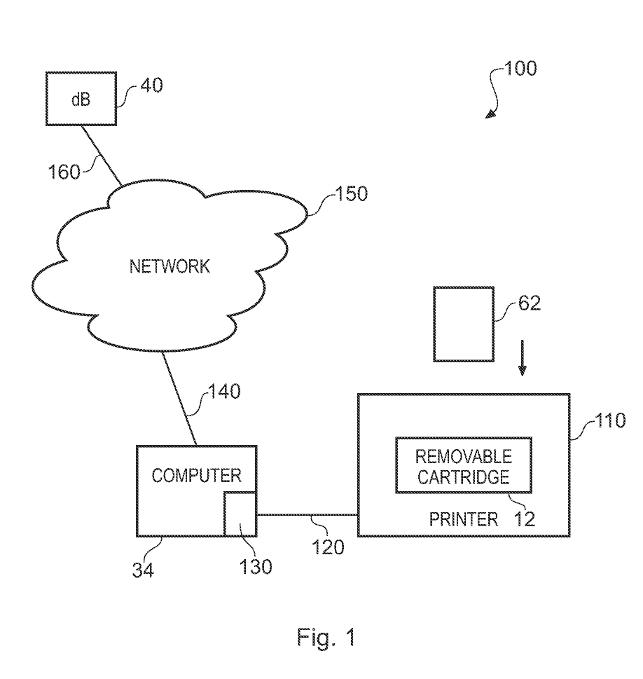

FIG. 1 is a schematic view of a system 100 for identifying an article 62 from a signature based upon an intrinsic characteristic of the article 62. The system 100 comprises a computer system 34 connected via a network 150 to a remote database 40 that stores signatures. The network 150 may be the Internet, for example.

The computer system 34 is also connected through an interface 130 to a reprographics device, in this case a printer 1 10. The printer 110 contains a removable cartridge 12 that can be used to generate a signature from an article 62 as it is fed through the printer 110. In this case, the interface 130 sends print commands to the removable cartridge 12 receives values for scanned data points obtained by a signature scanning unit (not shown) in the removable cartridge 12.

In one version, dots can be printed onto the article 62, which may, for example, be a sheet of paper. An initial scan, and any subsequent scans to identify the article 62 can then be performed between the dots to ensure subsequent registration of the data points for matching signatures.

In another version, a box may be printed on the article and a scan may be performed within the boundaries of the box. This is the so-called LSA™ mode of operation. A raster scan can be used to find the box when doing a validation scan.

In various systems, the signature can be scanned whilst an article 62 such as a document is being printed. The signature can then be sent for storage at the database 40, following which it can be accessed for comparison to a signature obtained by a validation scan to determine the authenticity of the article 62. An article 62 might also be provided with a bar code that encodes its unique identifying signature.

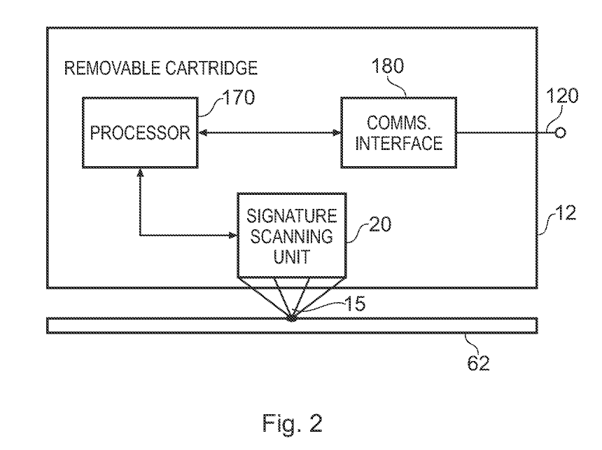

FIG. 2 is a schematic view of a removable cartridge 12 for a reprographics device 110. The removable cartridge 12 is shown in operation scanning an article 62.

The removable cartridge 12 may be of the type that is described in European Patent Application number EP 1 029 685 modified to include a signature scanning unit 20 of the type described in greater detail below. The contents of EP 1 029 685 are hereby incorporated by reference into this specification in their entirety.

The removable cartridge 12 includes a processor 170 that is adapted to control the signature scanning unit 20 and to acquire data points for transmission through a communications interface 180 to the computer 34 via the interface 130 for generating the signature at the computer 34. The communications interface 180 manages data transfer between the removable cartridge 12 and the interface 130 across a communications bus 120. The communications bus 120 may comprise a connector that is used ordinarily to indicate when a conventional cartridge is out of ink, toner, etc.

In alternative embodiments, the communications interface 180 may comprise a radio transmitter device, such as, for example, a commercially available Bluetooth™ transmitter/receiver. In this case, the communications bus 120 may not be needed and all data and/or control signals may be transmitted between the computer 34 and the removable cartridge 12.

Whilst in the embodiment described the signature is derived by the computer 34, those skilled in the art will understand that the processor 170 might be used to derive the signature within the removable cartridge 12 itself.

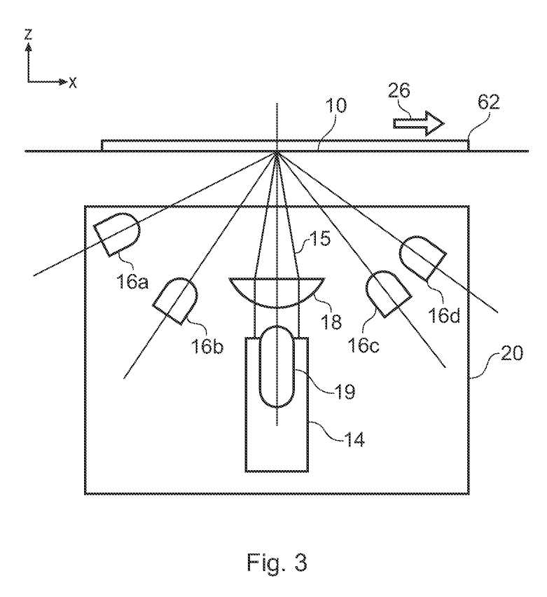

FIG. 3 shows a schematic side view of a first example of a signature scanning unit 20. The signature scanning unit 20 is for measuring a signature from an article 62 arranged in a reading volume of the apparatus. The reading volume is formed by a reading aperture 10 which is provided as a slit in a housing of the removable cartridge 12. The housing contains the main optical components of the signature scanning unit 20. The slit has its major extent in the x direction (see inset axes in the drawing). The principal optical components are a laser source 14 for generating a coherent laser beam 15 and a detector arrangement 16 made up of a plurality of k photodetector elements, where k=4 in this example, labelled 16a, 16b, 16c and 16d. The laser beam 15 is focused by a cylindrical lens 18 into an elongate focus extending in the y direction (perpendicular to the plane of the drawing) and lying in the plane of the reading aperture. In one example reader, the elongate focus has a major axis dimension of about 2 mm and a minor axis dimension of about 40 micrometres. These optical components are contained in a subassembly. In the present example, the four detector elements 16a . . . d are distributed either side of the beam axis offset at different angles in an interdigitated arrangement from the beam axis to collect light scattered in reflection from an article present in the reading volume. In the present example, the offset angles are −70, −20, +30 and +50 degrees. The angles either side of the beam axis are chosen so as not to be equal so that the data points they collect are as independent as possible. All four detector elements are arranged in a common plane. The photodetector elements 16a . . . d detect light scattered from an article placed on the housing when the coherent beam scatters from the reading volume. As illustrated, the source is mounted to direct the laser beam 15 with its beam axis in the z direction, so that it will strike an article in the reading aperture at normal incidence.

Generally it is desirable that the depth of focus is large, so that any differences in the article positioning in the z direction do not result in significant changes in the size of the beam in the plane of the reading aperture. In the present example, the depth of focus is approximately 0.5 mm which is sufficiently large to produce good results where the position of the article relative to the scanner can be controlled to some extent. The parameters, of depth of focus, numerical aperture and working distance are interdependent, resulting in a well known trade off between spot size and depth of focus.

A drive motor (not shown) of the printer 110 is arranged to providing linear motion of the article 62, as indicated by the arrow 26, within the reading volume. The drive motor thus serves to move the coherent beam relative to the article linearly in the x direction. Beam 15 thus scans the article 62 in a direction transverse to the major axis of the elongate focus. Since the coherent beam 15 is dimensioned at its focus to have a cross-section in the xz plane (plane of the drawing) that is much smaller than a projection of the reading volume in a plane normal to the coherent beam, i.e. in the plane of the housing wall in which the reading aperture is set, a scan of the drive motor will cause the coherent beam 15 to sample many different parts of the reading volume under action of the drive motor.

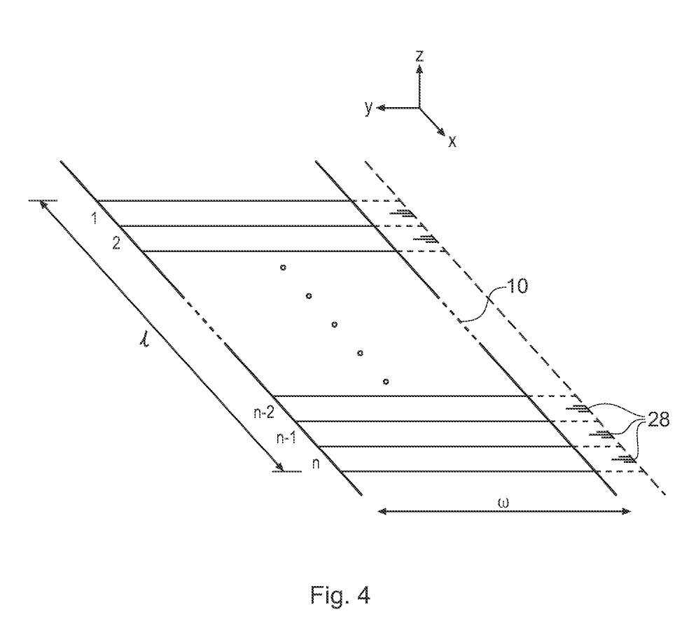

FIG. 4 is included to illustrate this sampling and is a schematic perspective view showing how the reading area is sampled n times by scanning an elongate beam across it. The sampling positions of the focused laser beam as it is scanned along the reading aperture under action of the drive is represented by the adjacent rectangles numbered 1 to n which sample an area of length ‘l’ and width ‘w’. Data collection is made so as to collect signal at each of the n positions as the drive is scanned along the slit. Consequently, a sequence of k x n data points are collected that relate to scatter from the n different illustrated parts of the reading volume.

Also illustrated schematically are optional distance marks 28 formed on the article 62 along the x direction, i.e. the scan direction. An example spacing between the marks in the x-direction is 300 micrometres. These marks are sampled by a tail of the elongate focus and provide for linearisation of the data in the x direction in situations where such linearisation is required, as is described in more detail further below. The measurement is performed by an additional phototransistor 19 which is a directional detector arranged to collect light from the area of the marks 28 adjacent the slit.

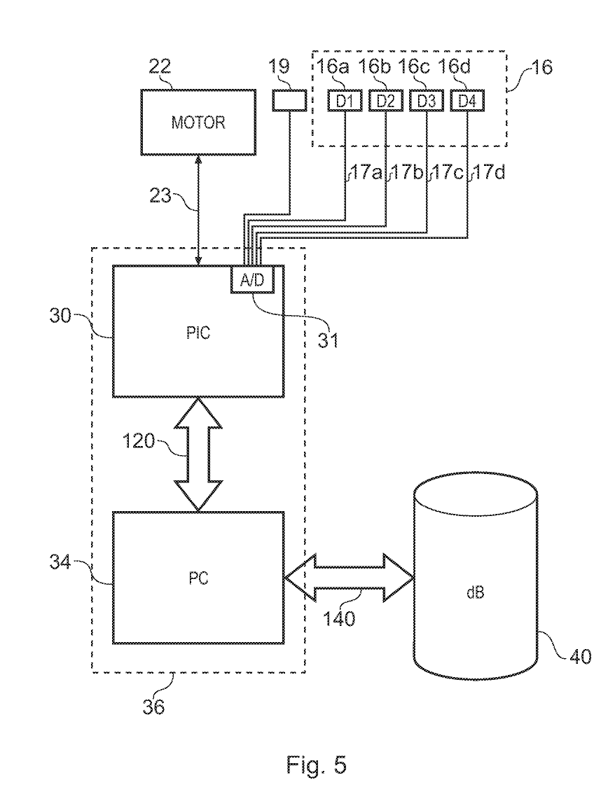

In alternative examples, the marks 28 can be read by a dedicated encoder emitter/detector module 19 that is part of the signature scanning unit 20. Encoder emitter/detector modules are used in bar code readers. In one example, an Agilent HEDS-1500 module that is based on a focused light emitting diode (LED) and photodetector can be used. The module signal is fed into the PIC ADC as an extra detector channel (see discussion of FIG. 5 below).

With an example minor dimension of the focus of 40 micrometers, and a scan length in the x direction of 2 cm, n=500, giving 2000 data points with k=4. A typical range of values for k x n depending on desired security level, article type, number of detector channels ‘k’ and other factors is expected to be 100<k x n<10,000. It has also been found that increasing the number of detectors k also improves the insensitivity of the measurements to surface degradation of the article through handling, printing etc. In practice, with the prototypes used to date, a rule of thumb is that the total number of independent data points, i.e. k x n, should be 500 or more to give an acceptably high security level with a wide variety of surfaces. Other minima (either higher or lower) may apply where a scanner is intended for use with only one specific surface type or group of surface types.

FIG. 5 is a block schematic diagram of functional components of the system 100. The printer motor 22 is connected to a programmable interrupt controller (PIC) 30 through an electrical link 23. The detectors 16a . . . d of the detector module 16 are connected through respective electrical connection lines 17a . . . d to an analogue-to-digital converter (ADC) that is part of the PIC 30. A similar electrical connection line 21 connects the optional marker reading detector 19 to the PIC 30. It will be understood that optical or wireless links may be used instead of, or in combination with, electrical links. The PIC 30 is interfaced with the personal computer (PC) 34 through a data connection 120. The PC 34 may be a desktop or a laptop. As an alternative to a PC, other intelligent devices may be used, for example a personal digital assistant (PDA) or a dedicated electronics unit. The PIC 30 and PC 34 collectively form a data acquisition and processing module 36 for determining a signature of the article from the set of data points collected by the detectors 16a . . . d.

In some examples, the PC 34 can have access through an interface connection 140 to a database (dB) 40. The database 40 may be resident on the PC 34 in memory, or stored on a drive thereof Alternatively, the database 40 may be remote from the PC 34 and accessed by wireless communication, for example using mobile telephony services or a wireless local area network (LAN) in combination with the internet Moreover, the database 40 may be stored locally on the PC 34, but periodically downloaded from a remote source. The database may be administered by a remote entity, which entity may provide access to only a part of the total database to the particular PC 34, and/or may limit access the database on the basis of a security policy.

The database 40 can contain a library of previously recorded signatures. The PC 34 can be programmed so that in use it can access the database 40 and performs a comparison to establish whether the database 40 contains a match to the signature of the article that has been placed in the reading volume. The PC 34 can also be programmed to allow a signature to be added to the database if no match is found.

The way in which data flow between the PC and database is handled can be dependent upon the location of the PC and the relationship between the operator of the PC and the operator of the database. For example, if the PC and reader are being used to confirm the authenticity of an article, then the PC will not need to be able to add new articles to the database, and may in fact not directly access the database, but instead provide the signature to the database for comparison. In this arrangement the database may provide an authenticity result to the PC to indicate whether the article is authentic. On the other hand, if the PC and reader are being used to record or validate an item within the database, then the signature can be provided to the database for storage therein, and no comparison may be needed. In this situation a comparison could be performed however, to avoid a single item being entered into the database twice.

Thus there has now been described an example of a scanning and signature generation apparatus suitable for use in a security mechanism for remote verification of article authenticity. Such a system can be deployed to allow an article to be scanned in more than one location, and for a check to be performed to ensure that the article is the same article in both instances, and optionally for a check to performed to ensure that the article has not been tampered with between initial and subsequent scannings.

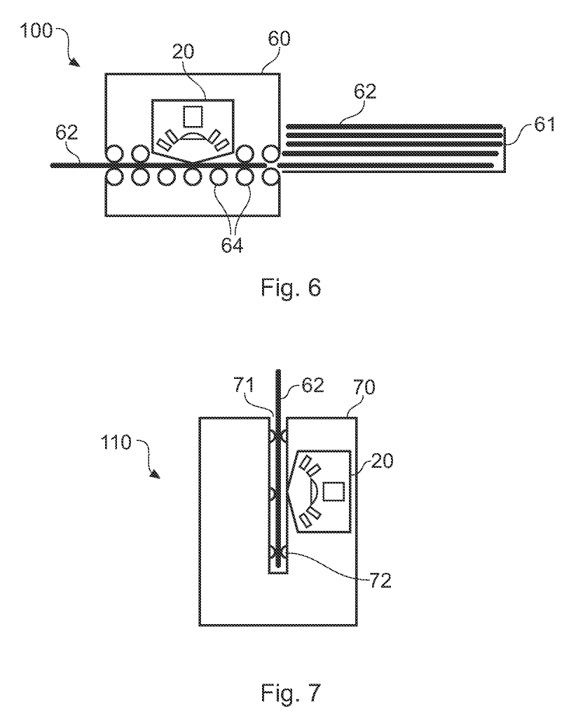

FIG. 6 is a schematic view of a reprographics device 110 incorporating a signature scanning unit 20. In this example, a housing 60 is provided, having an article feed tray 61 attached thereto. The tray 61 can hold one or more articles 62 for scanning by the reader. A motor can drive feed rollers 64 to carry an article 62 through the device and across a scanning aperture of an optics subassembly as described above. Thus the article 62 can be scanned by the optics subassembly in the manner discussed above in a manner whereby the relative motion between optics subassembly and article is created by movement of the article. Using such a system, the motion of the scanned item can be controlled using the motor with sufficient linearity that the use of distance marks and linearisation processing may be unnecessary. The apparatus could follow any conventional format for document scanners, photocopiers or document management systems. Such a scanner may be configured to handle line-feed sheets (where multiple sheets are connected together by, for example, a perforated join) as well as or instead of handing single sheets.

Thus there has now been described a reprographics device suitable for scanning articles in an automated feeder type device. Depending upon the physical arrangement of the feed arrangement, the scanner may be able to scan one or more single sheets of material, joined sheets or material or three-dimensional items such as packaging cartons.

FIG. 7 shows another example of a schematic view of a reprographics device 110 incorporating a signature scanning unit 20. In this example, the article 62 is moved through the reader by a user. A housing 70 can be provided with a slot 71 therein for insertion of an article for scanning. An optics subassembly 20 can be provided with a scanning aperture directed into the slot 71 so as to be able to scan an article 62 passed through the slot. Additionally, guide elements 72 may be provided in the slot 71 to assist in guiding the article to the correct focal distance from the optics sub-assembly 20 and/or to provide for a constant speed passage of the article through the slot. A printing or embossing head (not shown) may also be incorporated in the housing 70 to provide reprographic functionality.

Reprographic scanners of this type may be particularly suited to making and/or scanning articles which are at least partially rigid, such as card, plastic or metal sheets. Such sheets may, for example, be plastic items such as credit cards or other bank cards.

Thus there have now been described an arrangement for manually initiated production/scanning of an article. This could be used for scanning bank cards and/or credit cards as they are made and/or subsequently. E.g. a card could be scanned at a terminal where that card is presented for use, and a signature taken from the card could be compared to a stored signature for the card to check the authenticity and un-tampered nature of the card. Such a device could also be used, for example in the context of reading a military-style embossed metal ID-tag (which tags are often also carried by allergy sufferers to alert others to their allergy). This could enable medical personnel treating a patient to ensure that the patient being treated was in fact the correct bearer of the tag. Likewise, in a casualty situation, a recovered tag could be scanned for authenticity to ensure that a casualty has been correctly identified before informing family and/or colleagues.

The above-described examples are based on localised excitation with a coherent light beam of small cross-section in combination with detectors that accept light signal scattered over a much larger area that includes the local area of excitation. It is possible to design a functionally equivalent optical system which is instead based on directional detectors that collect light only from localised areas in combination with excitation of a much larger area.

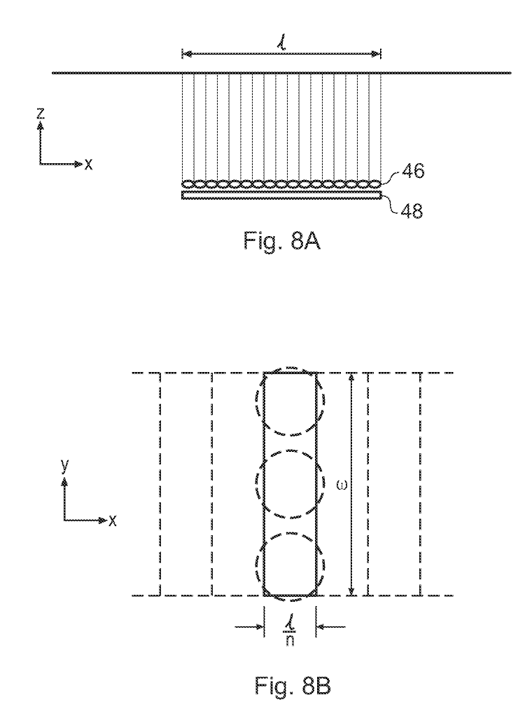

FIG. 8A shows schematically in side view such an imaging arrangement for a signature scanning unit which is based on directional light collection and blanket illumination with a coherent beam. An array detector 48 is arranged in combination with a cylindrical microlens array 46 so that adjacent strips of the detector array 48 only collect light from corresponding adjacent strips in the reading volume. With reference to FIG. 4, each cylindrical microlens is arranged to collect light signal from one of the n sampling strips. The coherent illumination can then take place with blanket illumination of the whole reading volume (not shown in the illustration).

A hybrid system with a combination of localised excitation and localised detection may also be useful in some cases.

FIG. 8B shows schematically in plan view the optical footprint of such a hybrid imaging arrangement for a signature scanning unit in which directional detectors are used in combination with localised illumination with an elongate beam. This example may be considered to be a development of the example of FIG. 3 in which directional detectors are provided. In this example three banks of directional detectors are provided, each bank being targeted to collect light from different portions along the ‘l×w’ excitation strip. The collection area from the plane of the reading volume are shown with the dotted circles, so that a first bank of, for example two, detectors collects light signal from the upper portion of the excitation strip, a second bank of detectors collects light signal from a middle portion of the excitation strip and a third bank of detectors collects light from a lower portion of the excitation strip. Each bank of detectors is shown having a circular collection area of diameter approximately l/m, where m is the number of subdivisions of the excitation strip, where m=3 in the present example. In this way the number of independent data points can be increased by a factor of m for a given scan length l. As described further below, one or more of different banks of directional detectors can be used for a purpose other than collecting light signal that samples a speckle pattern. For example, one of the banks may be used to collect light signal in a way optimised for barcode scanning. If this is the case, it will generally be sufficient for that bank to contain only one detector, since there will be no advantage obtaining cross-correlations when only scanning for contrast.

Having now described the principal structural components and functional components of various removable cartridge apparatuses containing signature scanning units, the numerical processing used to determine a signature will now be described. It will be understood that this numerical processing can be implemented for the most part in a computer program that runs on the PC 34 with some elements subordinated to the PIC 30. In alternative examples, the numerical processing could be performed by a dedicated numerical processing device or devices in hardware or firmware, for example, provided in the removable cartridges themselves.

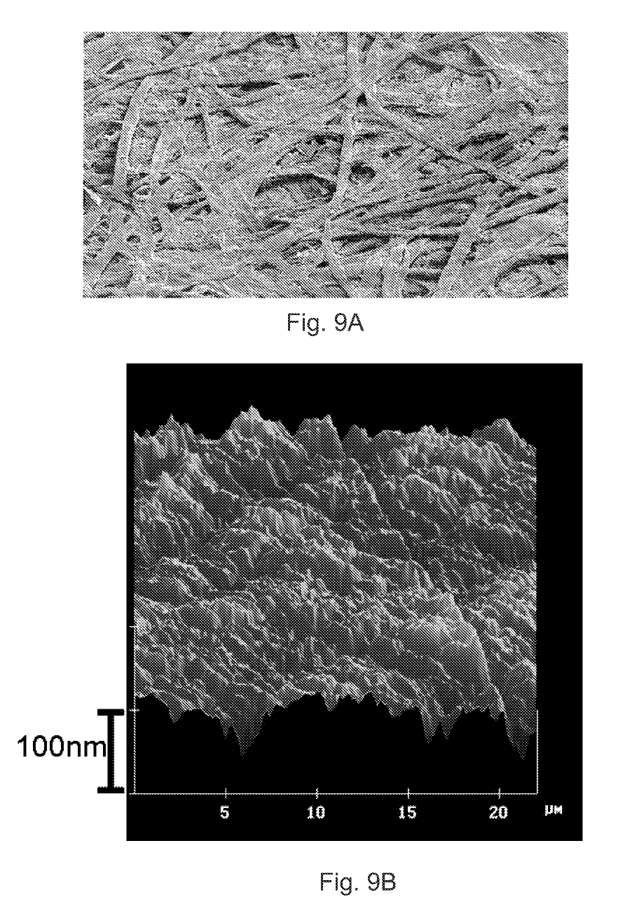

FIG. 9A is a microscope image of a paper surface with the image covering an area of approximately 0.5×0.2 mm. This figure is included to illustrate that macroscopically flat surfaces, such as from paper, are in many cases highly structured at a microscopic scale. For paper, the surface is microscopically highly structured as a result of the intermeshed network of wood or other fibres that make up the paper. The figure is also illustrative of the characteristic length scale for the wood fibres which is around 10 microns. This dimension has the correct relationship to the optical wavelength of the coherent beam of the present example to cause diffraction and hence speckle, and also diffuse scattering which has a profile that depends upon the fibre orientation. It will thus be appreciated that if a signature scanning unit is to be designed for a specific class of goods, the wavelength of the laser can be tailored to the structure feature size of the class of goods to be scanned. It is also evident from the figure that the local surface structure of each piece of paper will be unique in that it depends on how the individual wood fibres are arranged. A piece of paper is thus no different from a specially created token, such as the special resin tokens or magnetic material deposits of the prior art, in that it has structure which is unique as a result of it being made by a process governed by laws of nature. The same applies to many other types of article.

FIG. 9B shows an equivalent image for a plastic surface. This atomic force microscopy image clearly shows the uneven surface of the macroscopically smooth plastic surface. As can be surmised from the figure, this surface is smoother than the paper surface illustrated in FIG. 9A, but even this level of surface undulation can be uniquely identified using the signature generation scheme of the present example.

In other words, it can be essentially pointless to go to the effort and expense of making specially prepared tokens, when unique characteristics are measurable in a straightforward manner from a wide variety of every day articles. The data collection and numerical processing of a scatter signal that takes advantage of the natural structure of an article's surface (or interior in the case of transmission) is now described.

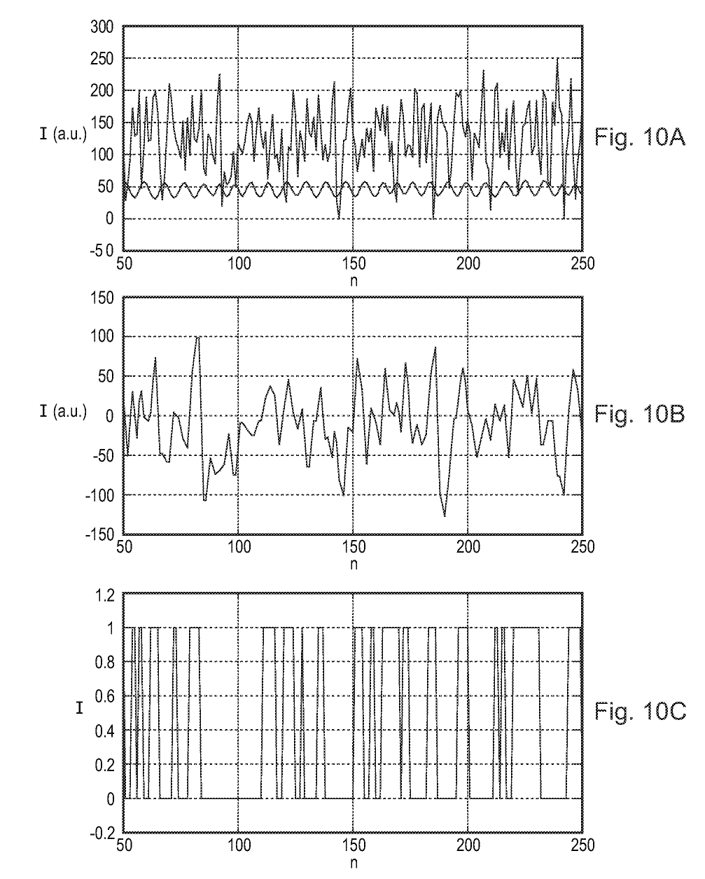

FIG. 10A shows raw data from a single one of the photodetectors 16a . . . d of the signature scanning unit of FIG. 3. The graph plots signal intensity I in arbitrary units (a.u.) against point number n (see FIG. 4). The higher trace fluctuating between I=0-250 is the raw signal data from photodetector 16a. The lower trace is the encoder signal picked up from the markers 28 (see FIG. 4) which is at around I=50.

FIG. 10B shows the photodetector data of FIG. 10A after linearisation with the encoder signal (n.b. although the x axis is on a different scale from FIG. 10A, this is of no significance). As noted above, where a movement of the article relative to the signature scanning unit is sufficiently linear, there may be no need to make use of a linearisation relative to alignment marks. In addition, the average of the intensity has been computed and subtracted from the intensity values. The processed data values thus fluctuate above and below zero.

FIG. 10C shows the data of FIG. 10B after digitisation. The digitisation scheme adopted is a simple binary one in which any positive intensity values are set at value 1 and any negative intensity values are set at zero. It will be appreciated that multi-state digitisation could be used instead, or any one of many other possible digitisation approaches. The main important feature of the digitisation is merely that the same digitisation scheme is applied consistently.

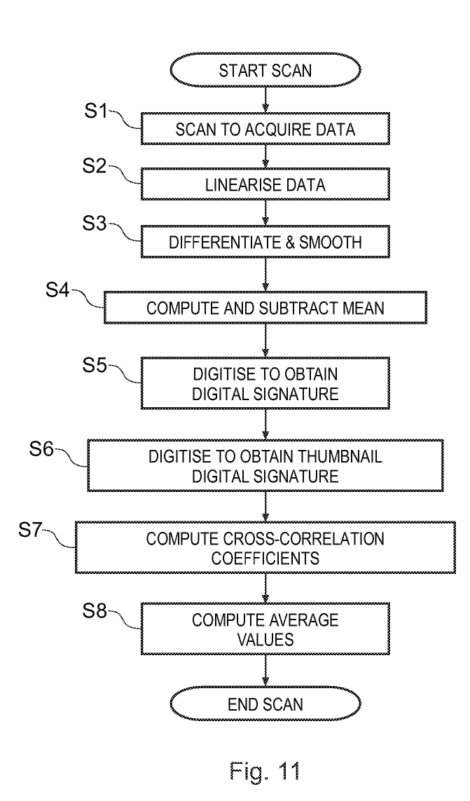

FIG. 11 is a flow diagram showing how a signature of an article is generated from a scan.

Step S1 is a data acquisition step during which the optical intensity at each of the photodetectors is acquired approximately every 1 ms during the entire length of scan. Simultaneously, the encoder signal is acquired as a function of time. It is noted that if the scan motor has a high degree of linearisation accuracy (e.g. as would a stepper motor/printer motor) then linearisation of the data may not be required. The data is acquired by the PIC 30 taking data from the ADC 3 1. The data points are transferred in real time from the PIC 30 to the PC 34. Alternatively, the data points could be stored in memory in the PIC 30 and then passed to the PC 34 at the end of a scan. The number n of data points per detector channel collected in each scan is defined as N in the following. Further, the value aₖ(i) is defined as the i-th stored intensity value from photodetector k, where i runs from 1 to N. Examples of two raw data sets obtained from such a scan are illustrated in FIG. 10A.

Step S2 uses numerical interpolation to locally expand and contract aₖ(i) so that the encoder transitions are evenly spaced in time. This corrects for local variations in the motor speed. This step can be performed in the PC 34 by a computer program.

Step S3 is an optional step. If performed, this step numerically differentiates the data with respect to time. It may also be desirable to apply a weak smoothing function to the data. Differentiation may be useful for highly structured surfaces, as it serves to attenuate uncorrelated contributions from the signal relative to correlated (speckle) contributions.

Step S4 is a step in which, for each photodetector, the mean of the recorded signal is taken over the N data points. For each photodetector, this mean value is subtracted from all of the data points so that the data are distributed about zero intensity. Reference is made to FIG. 10B which shows an example of a scan data set after linearisation and subtraction of a computed average.

Step S5 digitises the analogue photodetector data to compute a digital signature representative of the scan. The digital signature is obtained by applying the rule: aₖ(i)>0 maps onto binary ‘1’ and aₖ(i)<=0 maps onto binary ‘0’. The digitised data set is defined as dₖ(i) where i runs from 1 to N. The signature of the article may incorporate further components in addition to the digitised signature of the intensity data just described. These further optional signature components are now described.

Step S6 is an optional step in which a smaller ‘thumbnail’ digital signature is created. This is done either by averaging together adjacent groups of m readings, or more preferably by picking every cth data point, where c is the compression factor of the thumbnail. The latter is preferred since averaging may disproportionately amplify noise. The same digitisation rule used in Step S5 is then applied to the reduced data set. The thumbnail digitisation is defined as tₖ(i) where i runs 1 to N/c and c is the compression factor.

Step S7 is an optional step applicable when multiple detector channels exist. The additional component is a cross-correlation component calculated between the intensity data obtained from different ones of the photodetectors. With 2 channels there is one possible cross-correlation coefficient, with 3 channels up to 3, and with 4 channels up to 6 etc. The cross-correlation coefficients are useful, since it has been found that they are good indicators of material type. For example, for a particular type of document, such as a passport of a given type, or laser printer paper, the cross-correlation coefficients always appear to lie in predictable ranges. A normalised cross-correlation can be calculated between aₖ(i) and aₗ(i), where k≠l and k,l vary across all of the photodetector channel numbers. The normalised cross-correlation function Γ is defined as

$$Γ ( k , l ) = \frac{{\sum }_{i = 1}^{N} {a}_{k} ( i ) {a}_{l} ( i )}{\sqrt{( {\sum }_{i = 1}^{N} {{a}_{k} ( i )}^{2} ) ( {\sum }_{i = 1}^{N} {{a}_{l} ( i )}^{2} )}}$$

Another aspect of the cross-correlation function that can be stored for use in later verification is the width of the peak in the cross-correlation function, for example the full width half maximum (FWHM). The use of the cross-correlation coefficients in verification processing is described further below.

Step S8 is another optional step which is to compute a simple intensity average value indicative of the signal intensity distribution. This may be an overall average of each of the mean values for the different detectors or an average for each detector, such as a root mean square (rms) value of aₖ(i). If the detectors are arranged in pairs either side of normal incidence as in the signature scanning unit described above, an average for each pair of detectors may be used. The intensity value has been found to be a good crude filter for material type, since it is a simple indication of overall reflectivity and roughness of the sample. For example, one can use as the intensity value the unnormalised rms value after removal of the average value, i.e. the DC background.

The signature data obtained from scanning an article can be compared against records held in a signature database for verification purposes and/or written to the database to add a new record of the signature to extend the existing database.

A new database record will include the digital signature obtained in Step S5. This can optionally be supplemented by one or more of its smaller thumbnail version obtained in Step S6 for each photodetector channel, the cross-correlation coefficients obtained in Step S7 and the average value(s) obtained in Step S8. Alternatively, the thumbnails may be stored on a separate database of their own optimised for rapid searching, and the rest of the data (including the thumbnails) on a main database.

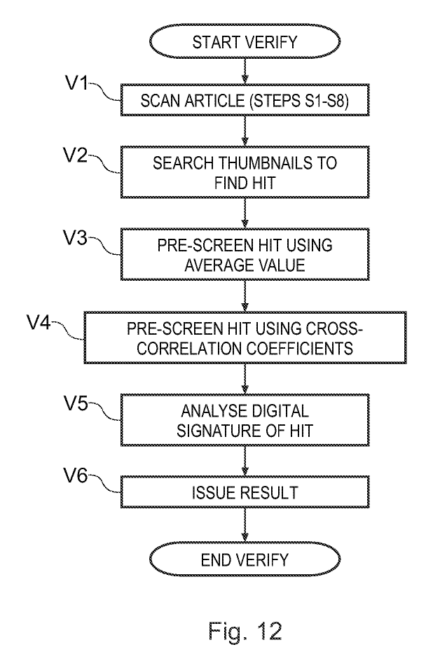

FIG. 12 is a flow diagram showing how a signature of an article obtained from a scan can be verified against a signature database.

In a simple implementation, the database could simply be searched to find a match based on the full set of signature data. However, to speed up the verification process, the process can use the smaller thumbnails and pre-screening based on the computed average values and cross-correlation coefficients as now described.

Verification Step V1 is the first step of the verification process, which is to scan an article according to the process described above, i.e. to perform Scan Steps S1 to S8.

Verification Step V2 takes each of the thumbnail entries and evaluates the number of matching bits between it and tₖ(i+j), where j is a bit offset which is varied to compensate for errors in placement of the scanned area. The value of j is determined and then the thumbnail entry which gives the maximum number of matching bits. This is the ‘hit’ used for further processing.

Verification Step V3 is an optional pre-screening test that is performed before analysing the full digital signature stored for the record against the scanned digital signature. In this pre-screen, the rms values obtained in Scan Step S8 are compared against the corresponding stored values in the database record of the hit. The ‘hit’ is rejected from further processing if the respective average values do not agree within a predefined range. The article is then rejected as non-verified (i.e. jump to Verification Step V6 and issue fail result).

Verification Step V4 is a further optional pre-screening test that is performed before analysing the full digital signature. In this pre-screen, the cross-correlation coefficients obtained in Scan Step S7 are compared against the corresponding stored values in the database record of the hit. The ‘hit’ is rejected from further processing if the respective cross-correlation coefficients do not agree within a predefined range. The article is then rejected as non-verified (i.e. jump to Verification Step V6 and issue fail result).

Another check using the cross-correlation coefficients that could be performed in Verification Step V4 is to check the width of the peak in the cross-correlation function, where the cross-correlation function is evaluated by comparing the value stored from the original scan in Scan Step S7 above and the re-scanned value:

$${Γ}_{k , l} ( j ) = \frac{{\sum }_{i = 1}^{N} {a}_{k} ( i ) {a}_{l} ( i + j )}{\sqrt{( {\sum }_{i = 1}^{N} {{a}_{k} ( i )}^{2} ) ( {\sum }_{i = 1}^{N} {{a}_{l} ( i )}^{2} )}}$$

If the width of the re-scanned peak is significantly higher than the width of the original scan, this may be taken as an indicator that the re-scanned article has been tampered with or is otherwise suspicious. For example, this check should beat a fraudster who attempts to fool the system by printing a bar code or other pattern with the same intensity variations that are expected by the photodetectors from the surface being scanned.

Verification Step V5 is the main comparison between the scanned digital signature obtained in Scan Step S5 and the corresponding stored values in the database record of the hit. The full stored digitised signature, dₖ^{db}(i) is split into n blocks of q adjacent bits on k detector channels, i.e. there are qk bits per block. A typical value for q is 4 and a typical value for k is 4, making typically 16 bits per block. The qk bits are then matched against the qk corresponding bits in the stored digital signature dₖ^{db}(i+j). If the number of matching bits within the block is greater or equal to some pre-defined threshold zₜₕᵣₑₛₕ, then the number of matching blocks is incremented. A typical value for zₜₕᵣₑₛₕ is 13. This is repeated for all n blocks. This whole process is repeated for different offset values of j, to compensate for errors in placement of the scanned area, until a maximum number of matching blocks is found. Defining M as the maximum number of matching blocks, the probability of an accidental match is calculated by evaluating:

$$p ( M ) = {\sum }_{w = n - M}^{n} {{s}^{w} ( 1 - s )}_{w}^{n - wn} C$$

where s is the probability of an accidental match between any two blocks (which in turn depends upon the chosen value of z_{threshold}), M is the number of matching blocks and p(M) is the probability of M or more blocks matching accidentally. The value of s is determined by comparing blocks within the data base from scans of different objects of similar materials, e.g. a number of scans of paper documents etc. For the case of q=4, k=4 and z_{threshold}=13, we typical value of s is 0.1. If the qk bits were entirely independent, then probability theory would give s=0.01 for z_{threshold}=13. The fact that a higher value is found empirically is because of correlations between the k detector channels and also correlations between adjacent bits in the block due to a finite laser spot width. A typical scan of a piece of paper yields around 314 matching blocks out of a total number of 510 blocks, when compared against the data base entry for that piece of paper. Setting M=314, n=510, s=0.1 for the above equation gives a probability of an accidental match of 10⁻¹⁷⁷.

Verification Step V6 issues a result of the verification process. The probability result obtained in Verification Step V5 may be used in a pass/fail test in which the benchmark is a pre-defined probability threshold. In this case the probability threshold may be set at a level by the system, or may be a variable parameter set at a level chosen by the user. Alternatively, the probability result may be output to the user as a confidence level, either in raw form as the probability itself, or in a modified form using relative terms (e.g. no match/poor match/good match/excellent match) or other classification.

It will be appreciated that many variations are possible. For example, instead of treating the cross-correlation coefficients as a pre-screen component, they could be treated together with the digitised intensity data as part of the main signature. For example the cross-correlation coefficients could be digitised and added to the digitised intensity data. The cross-correlation coefficients could also be digitised on their own and used to generate bit strings or the like which could then be searched in the same way as described above for the thumbnails of the digitised intensity data in order to find the hits.

Thus there have now been described a number of examples arrangements for scanning an article to obtain a signature based upon intrinsic properties of that article. There have also been described examples of how that signature can be generated from the data collected during the scan, and how the signature can be compared to a later scan from the same or a different article to provide a measure of how likely it is that the same article has been scanned in the later scan.

Such a system has many applications, amongst which are security and confidence screening of items for fraud prevention and item traceability.

In some examples, the method for extracting a signature from a scanned article can be optimised to provide reliable recognition of an article despite deformations to that article caused by, for example, stretching or shrinkage. Such stretching or shrinkage of an article may be caused by, for example, water damage to a paper or cardboard based article.

Also, an article may appear to a scanner comprising a signature scanning unit to be stretched or shrunk if the relative speed of the article to the sensors in the scanner is non-linear. This may occur if, for example the article is being moved along a conveyor system, or if the article is being moved through a scanner by a human holding the article. An example of a likely scenario for this to occur is where a human scans, for example, a bank card using a scanner such as that described with reference to FIG. 7 above.

As described above, where a scanner is based upon a scan head which moves within the scanner unit relative to an article held stationary against or in the scanner, then linearisation guidance can be provided by the optional distance marks 28 to address any non-linearities in the motion of the scan head. Where the article is moved by a human, these non-linearities can be greatly exaggerated

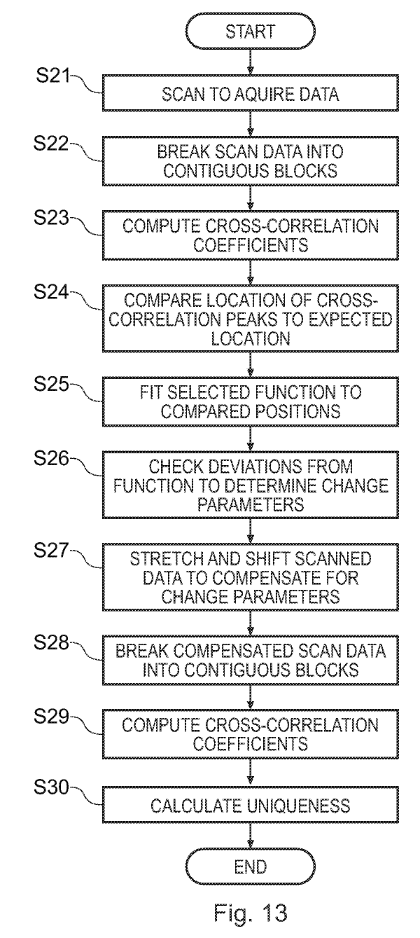

To address recognition problems which could be caused by these non-linear effects, it is possible to adjust the analysis phase of a scan of an article. Thus a modified validation procedure will now be described with reference to FIG. 13. The process implemented in this example uses a block-wise analysis of the data to address the non-linearities.

The process carried out in accordance with FIG. 13, can include some or all of the steps of smoothing and differentiating the data, computing and subtracting the mean, and digitisation for obtaining the signature and thumbnail described with reference to FIG. 11, but are not shown in FIG. 13 so as not to obscure the content of that figure.

As shown in FIG. 13, the scanning process for a validation scan using a block-wise analysis starts at step S21 by performing a scan of the article to acquire the data describing the intrinsic properties of the article. This scanned data is then divided into contiguous blocks (which can be performed before or after digitisation and any smoothing/differentiation or the like) at step S22. In one example, a scan length of 64 mm is divided into eight equal length blocks. Each block therefore represents a subsection of scanned area of the scanned article.

For each of the blocks, a cross-correlation is performed against the equivalent block for each stored signature with which it is intended that article be compared at step S23. This can be performed using a thumbnail approach with one thumbnail for each block. The results of these cross-correlation calculations are then analysed to identify the location of the cross-correlation peak. The location of the cross-correlation peak is then compared at step S24 to the expected location of the peak for the case were a perfectly linear relationship to exist between the original and later scans of the article.

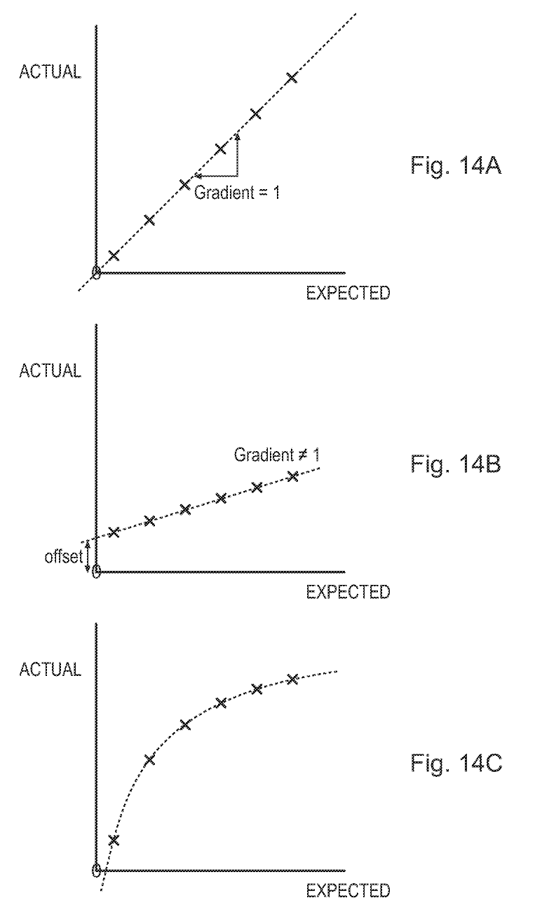

This relationship can be represented graphically as shown in FIGS. 14A, 14B and 14C. In the example of FIG. 14A, the cross-correlation peaks are exactly where expected, such that the motion of the scan head relative to the article has been perfectly linear and the article has not experienced stretch or shrinkage. Thus a plot of actual peak positions against expected peak results in a straight line which passes through the origin and has a gradient of 1.

In the example of FIG. 14B, the cross-correlation peaks are closer together than expected, such that the gradient of a line of best fit is less than one. Thus the article has shrunk relative to its physical characteristics upon initial scanning. Also, the best fit line does not pass through the origin of the plot. Thus the article is shifted relative to the scan head compared to its position upon initial scanning.

In the example of FIG. 14C, the cross correlation peaks do not form a straight line. In this example, they approximately fit to a curve representing a y² function. Thus the movement of the article relative to the scan head has slowed during the scan. Also, as the best fit curve does not cross the origin, it is clear that the article is shifted relative to its position upon initial scanning.

A variety of functions can be test-fitted to the plot of points of the cross-correlation peaks to find a best-fitting function. Thus curves to account for stretch, shrinkage, misalignment, acceleration, deceleration, and combinations thereof can be used. Examples of suitable functions can include straight line functions, exponential functions, a trigonometric functions, x² functions and x³ functions.

Once a best-fitting function has been identified at step S25, a set of change parameters can be determined which represent how much each cross-correlation peak is shifted from its expected position at step S26. These compensation parameters can then, at step S27, be applied to the data from the scan taken at step S21 in order substantially to reverse the effects of the shrinkage, stretch, misalignment, acceleration or deceleration on the data from the scan. As will be appreciated, the better the best-fit function obtained at step S25 fits the scan data, the better the compensation effect will be.

The compensated scan data is then broken into contiguous blocks at step S28 as in step S22. The blocks are then individually cross-correlated with the respective blocks of data from the stored signature at step S29 to obtain the cross-correlation coefficients. This time the magnitude of the cross-correlation peaks are analysed to determine the uniqueness factor at step S29. Thus it can be determined whether the scanned article is the same as the article which was scanned when the stored signature was created.

Accordingly, there has now been described an example of a method for compensating for physical deformations in a scanned article, and for non-linearities in the motion of the article relative to the scanner. Using this method, a scanned article can be checked against a stored signature for that article obtained from an earlier scan of the article to determine with a high level of certainty whether or not the same article is present at the later scan. Thereby an article constructed from easily distorted material can be reliably recognised. Also, a scanner where the motion of the scanner relative to the article may be non-linear can be used, thereby allowing the use of a low-cost scanner without motion control elements.

Another characteristic of an article which can be detected using a block-wise analysis of a signature generated based upon an intrinsic property of that article is that of localised damage to the article. For example, such a technique can be used to detect modifications to an article made after an initial record scan.

For example, many documents, such as passports, ID cards and driving licenses, include photographs of the bearer. If an authenticity scan of such an article includes a portion of the photograph, then any alteration made to that photograph will be detected. Taking an arbitrary example of splitting a signature into 10 blocks, three of those blocks may cover a photograph on a document and the other seven cover another part of the document, such as a background material. If the photograph is replaced, then a subsequent rescan of the document can be expected to provide a good match for the seven blocks where no modification has occurred, but the replaced photograph will provide a very poor match. By knowing that those three blocks correspond to the photograph, the fact that all three provide a very poor match can be used to automatically fail the validation of the document, regardless of the average score over the whole signature.

Also, many documents include written indications of one or more persons, for example the name of a person identified by a passport, driving licence or identity card, or the name of a bank account holder. Many documents also include a place where written signature of a bearer or certifier is applied. Using a block-wise analysis of a signature obtained therefrom for validation can detect a modification to alter a name or other important word or number printed or written onto a document. A block which corresponds to the position of an altered printing or writing can be expected to produce a much lower quality match than blocks where no modification has taken place. Thus a modified name or written signature can be detected and the document failed in a validation test even if the overall match of the document is sufficiently high to obtain a pass result.

The area and elements selected for the scan area can depend upon a number of factors, including the element of the document which it is most likely that a fraudster would attempt to alter. For example, for any document including a photograph the most likely alteration target will usually be the photograph as this visually identifies the bearer. Thus a scan area for such a document might beneficially be selected to include a portion of the photograph. Another element which may be subjected to fraudulent modification is the bearer's signature, as it is easy for a person to pretend to have a name other than their own, but harder to copy another person's signature. Therefore for signed documents, particularly those not including a photograph, a scan area may beneficially include a portion of a signature on the document.

In the general case therefore, it can be seen that a test for authenticity of an article can comprise a test for a sufficiently high quality match between a verification signature and a record signature for the whole of the signature, and a sufficiently high match over at least selected blocks of the signatures. Thus regions important to the assessing the authenticity of an article can be selected as being critical to achieving a positive authenticity result.

In some examples, blocks other than those selected as critical blocks may be allowed to present a poor match result. Thus a document may be accepted as authentic despite being torn or otherwise damaged in parts, so long as the critical blocks provide a good match and the signature as a whole provides a good match.

Thus there have now been described a number of examples of a system, method and apparatus for identifying localised damage to an article, and for rejecting an inauthentic an article with localised damage or alteration in predetermined regions thereof Damage or alteration in other regions may be ignored, thereby allowing the document to be recognised as authentic.

In some scanner apparatuses, it is also possible that it may be difficult to determine where a scanned region starts and finishes. One approach to addressing this difficulty would be to define the scan area as starting at the edge of the article. As the data received at the scan head will undergo a clear step change when an article is passed though what was previously free space, the data retrieved at the scan head can be used to determine where the scan starts.

In this example, the scan head is operational prior to the application of the article to the scanner. Thus initially the scan head receives data corresponding to the unoccupied space in front of the scan head. As the article is passed in front of the scan head, the data received by the scan head immediately changes to be data describing the article. Thus the data can be monitored to determine where the article starts and all data prior to that can be discarded. The position and length of the scan area relative to the article leading edge can be determined in a number of ways. The simplest is to make the scan area the entire length of the article, such that the end can be detected by the scan head again picking up data corresponding to free space. Another method is to start and/or stop the recorded data a predetermined number of scan readings from the leading edge. Assuming that the article always moves past the scan head at approximately the same speed, this would result in a consistent scan area. Another alternative is to use actual marks on the article to start and stop the scan region, although this may require more work, in terms of data processing, to determine which captured data corresponds to the scan area and which data can be discarded.

Thus there have now been described a number of techniques for scanning an item to gather data based on an intrinsic property of the article, compensating if necessary for damage to the article or non-linearities in the scanning process, and comparing the article to a stored signature based upon a previous scan of an article to determine whether the same article is present for both scans.

When using a biometric technique such as the identity technique described with reference to FIGS. 1 to 14 above for the verification of the authenticity or identity of an article, difficulties can arise with the reproducibility of signatures based upon biometric characteristics. In particular, as well as the inherent tendency for a biometric signature generation system to return slightly different results in each signature generated from an article, where an article is subjected to a signature generation process at different signature generation apparatuses and at different times there is the possibility that a slightly different portion of the article is presented on each occasion, making reliable verification more difficult.

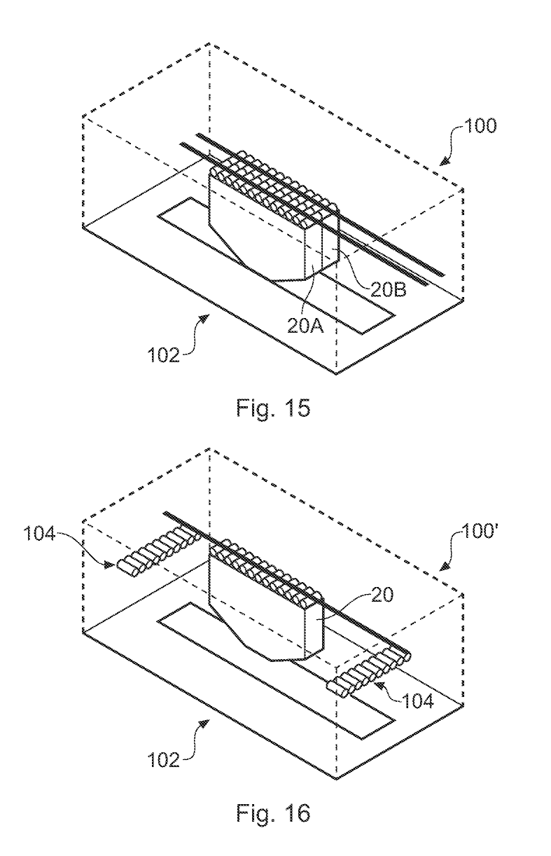

Examples of systems, methods and apparatuses for addressing these difficulties will now be described. First, with reference to FIG. 15, a multi-scan head signature generation apparatus for database creation will be described.

As shown in FIG. 15, a signature scanning unit 100 can include two optic subassemblies, each operable to create a signature for an article presented in a reading volume 102 of the reader unit. Thus an item presented for scanning to create a signature for recording of the item in an item database against which the item can later be verified, can be scanned twice, to create two signatures, spatially offset from one another by a likely alignment error amount. Thus a later scan of the item for identification or authenticity verification can be matched against both stored signatures. In some examples, a match against one of the two stored signatures can be considered as a successful match.

In some examples, further signature scanning units can be used, such that three, four or more signatures are created for each item. Each scan unit can be offset from the others in order to provide signatures from positions adjacent the intended scan location. Thus greater robustness to article misalignment on verification scanning can be provided.

The offset between scan units can be selected dependent upon factors such as a width of scanned portion of the article, size of scanned are relative to the total article size, likely misalignment amount during verification scanning, and article material.

Thus there has now been described a system for scanning an article to create a signature database against which an article can be checked to verify the identity and/or authenticity of the article.

An example of another system for providing multiple signatures in an article database will now be describe with reference to FIG. 16.

As shown in FIG. 16, a signature scanning units 100′ can have a single optic subassembly and an alignment adjustment unit 104. In use, the alignment adjustment unit 104 can alter the alignment of the optics subassembly relative to the reading volume 102 of the reader unit. Thus an article placed in the reading volume can be scanned multiple times by the optics subassembly in different positions so as to create multiple signatures for the article. In the present example, the alignment adjustment unit 104 can adjust the optics subassembly to read from two different locations. Thus a later scan of the item for identification or authenticity verification can be matched against both stored signatures. In some examples, a match against one of the two stored signatures can be considered as a successful match.

In some examples, further signature scanning unit positions can be used, such that three, four or more signatures are created for each item. Each scan unit position can be offset from the others in order to provide signatures from positions adjacent the intended scan location. Thus greater robustness to article misalignment on verification scanning can be provided.

The offset between scan unit positions can be selected dependent upon factors such as a width of scanned portion of the article, size of scanned are relative to the total article size, likely misalignment amount during verification scanning, and article material.

Thus there has now been described another example of a system for scanning an article to create a signature database against which an article can be checked to verify the identity and/or authenticity of the article.

Although it has been described above that a signature scanning unit used for record scanning (i.e. scanning of articles to create reference signatures against which the article can later be validated) can use multiple scan heads and/or scan head positions to create multiple signatures for an article, it is also possible to use a similar system for later validation scanning.

For example, a scanner for use in a validation scan may have multiple read heads to enable multiple validation scan signatures to be generated. Each of these multiple signatures can be compared to a database of recorded signatures, which may itself contain multiple signatures for each recorded item. Due to the fact that, although the different signatures for each item may vary these signatures will all still be extremely different to any signatures for any other items, a match between any one record scan signature and any one validation scan signature should provide sufficient confidence in the identity and/or authenticity of an item.

A multiple read head validation scanner can be arranged much as described with reference to FIG. 15 above. Likewise, a multiple read head position validation scanner can be arranged much as described with reference to FIG. 16 above. Also, for both the record and validation scanners, a system of combined multiple scan heads and multiple scan head positions per scan head can be combined into a single device.

In various embodiments, the signature scanning unit uses four single channel detectors (four simple phototransistors) which are angularly spaced apart to collect only four signal components from the scattered laser beam. The laser beam is focused to a spot covering only a very small part of the surface. Signal is collected from different localised areas on the surface by the four single channel detectors as the spot is scanned over the surface. The characteristic response from the article is thus made up of independent measurements from a large number (typically hundreds or thousands) of different localised areas on the article surface. Although four phototransistors are used, analysis using only data from a single one of the phototransistors shows that a unique characteristic response can be derived from this single channel alone. However, higher security levels are obtained if further ones of the four channels are included in the response.

In various embodiments, it can be ensured that different ones of the data points relate to scatter from different parts of the article, in that the detector arrangement includes a plurality of detector channels arranged and configured to sense scatter from respective different parts of the article. This can be achieved with directional detectors, local collection of signal with optical fibres or other measures. With directional detectors or other localised collection of signal, the coherent beam does not need to be focused. Indeed, the coherent beam could be static and illuminate the whole sampling volume. Directional detectors could be implemented by focusing lenses fused to, or otherwise fixed in relation to, the detector elements. Optical fibres may be used in conjunction with microlenses.

It is possible to make a workable reader when the detector arrangement consists of only a single detector channel. Other embodiments use a detector arrangement that comprises a group of detector elements angularly distributed and operable to collect a group of data points for each different part of the reading volume, preferably a small group of a few detector elements. Security enhancement is provided when the signature incorporates a contribution from a comparison between data points of the same group. This comparison may conveniently involve a cross-correlation.

Although a working reader can be made with only one detector channel, there are preferably at least 2 channels. This allows cross-correlations between the detector signals to be made, which is useful for the signal processing associated with determining the signature. It is envisaged that between 2 and 10 detector channels will be suitable for most applications with 2 to 4 currently being considered as the optimum balance between apparatus simplicity and security.

The detector elements are advantageously arranged to lie in a plane intersecting the reading volume with each member of the pair being angularly distributed in the plane in relation to the coherent beam axis, preferably with one or more detector elements either side of the beam axis. However, non-planar detector arrangements are also acceptable.

The use of cross-correlations of the signals obtained from the different detectors has been found to give valuable data for increasing the security levels and also for allowing the signatures to be more reliably reproducible over time. The utility of the cross-correlations is somewhat surprising from a scientific point of view, since speckle patterns are inherently uncorrelated (with the exception of signals from opposed points in the pattern). In other words, for a speckle pattern there will by definition be zero cross-correlation between the signals from the different detectors so long as they are not arranged at equal magnitude angles offset from the excitation location in a common plane intersecting the excitation location. The value of using cross-correlation contributions therefore indicates that an important part of the scatter signal is not speckle. The non-speckle contribution could be viewed as being the result of direct scatter, or a diffuse scattering contribution, from a complex surface, such as paper fibre twists. At present the relative importance of the speckle and non-speckle scatter signal contribution is not clear. However, it is clear from the experiments performed to date that the detectors are not measuring a pure speckle pattern, but a composite signal with speckle and non-speckle components.

Incorporating a cross-correlation component in the signature can also be of benefit for improving security. This is because, even if it is possible using high resolution printing to make an article that reproduces the contrast variations over the surface of the genuine article, this would not be able to match the cross-correlation coefficients obtained by scanning the genuine article.

In the one embodiment, the detector channels are made up of discrete detector components in the form of simple phototransistors. Other simple discrete components could be used such as PIN diodes or photodiodes. Integrated detector components, such as a detector array could also be used, although this would add to the cost and complexity of the device.

From initial experiments which modify the illumination angle of the laser beam on the article to be scanned, it also seems to be preferable in practice that the laser beam is incident approximately normal to the surface being scanned in order to obtain a characteristic that can be repeatedly measured from the same surface with little change, even when the article is degraded between measurements. At least some known readers use oblique incidence (see GB 2 221 870). Once appreciated, this effect seems obvious, but it is clearly not immediately apparent as evidenced by the design of some prior art speckle readers including that of GB 2 221 870 and indeed the first prototype reader built by the inventor. The inventor's first prototype reader with oblique incidence functioned reasonably well in laboratory conditions, but was quite sensitive to degradation of the paper used as the article. For example, rubbing the paper with fingers was sufficient to cause significant differences to appear upon re-measurement. The second prototype reader used normal incidence and has been found to be robust against degradation of paper by routine handling, and also more severe events such as: passing through various types of printer including a laser printer, passing through a photocopier machine, writing on, printing on, deliberate scorching in an oven, and crushing and reflattening.

It can therefore be advantageous to mount the source so as to direct the coherent beam onto the reading volume so that it will strike an article with near normal incidence. By near normal incidence means ±5, 10 or 20 degrees. Alternatively, the beam can be directed to have oblique incidence on the articles. This will usually have a negative influence in the case that the beam is scanned over the article.

It is also noted that in the signature scanning units described in the detailed description, the detector arrangement is arranged in reflection to detect radiation back scattered from the reading volume. However, if the article is transparent, the detectors could be arranged in transmission.

A system for identifying an article from a signature can be operable to access a database of previously recorded signatures and perform a comparison to establish whether the database contains a match to the signature of an article that has been placed in the reading volume. The database may be part of a mass storage device that forms part of a computer system, or may be at a remote location and accessed by the reader through a telecommunications link. The telecommunications link may take any conventional form, including wireless and fixed links, and may be available over the Internet. The data acquisition and processing module may be operable, at least in some operational modes, to allow the signature to be added to the database if no match is found.

When using a database, in addition to storing the signature it may also be useful to associate that signature in the database with other information about the article such as a scanned copy of the document, a photograph of a passport holder, details on the place and time of manufacture of the product, or details on the intended sales destination of vendable goods (e.g. to track grey importation).

The invention allows identification of articles made of a variety of different kinds of materials, such as paper, cardboard and plastic, for example.

By intrinsic structure we mean structure that the article inherently will have by virtue of its manufacture, thereby distinguishing over structure specifically provided for security purposes, such as structure given by tokens or artificial fibres incorporated in the article.

By paper or cardboard we mean any article made from wood pulp or equivalent fibre process. The paper or cardboard may be treated with coatings or impregnations or covered with transparent material, such as cellophane. If long-term stability of the surface is a particular concern, the paper may be treated with an acrylic spray-on transparent coating, for example.

Data points can thus be collected as a function of position of illumination by the coherent beam. This can be achieved either by scanning a localised coherent beam over the article, or by using directional detectors to collect scattered light from different parts of the article, or by a combination of both.

The signature is envisaged to be a digital signature in most applications. Typical sizes of the digital signature with current technology would be in the range 200 bits to 8 k bits, where currently it is preferable to have a digital signature size of about 2 k bits for high security.

A further implementation of the invention can be performed without storing the digital signatures in a database, but rather by labelling the entitlement token with a label derived from the signature, wherein the label conforms to a machine-readable encoding protocol.

Although the embodiments above have been described in considerable detail, numerous variations and modifications will become apparent to those skilled in the art once the above disclosure is fully appreciated. It is intended that the following claims be interpreted to embrace all such variations and modifications as well as their equivalents.

1. A removable cartridge for a reprographics device, the removable cartridge comprising a signature scanning unit for use in generating a signature based upon an intrinsic characteristic of an article, the signature scanning unit comprising:
a reading volume for receiving an article when the reprographics device is in operation;
a source for generating a coherent beam; and
a detector arrangement for collecting a set comprising groups of data points from signals obtained when the coherent beam scatters from different parts of an article in the reading volume, wherein different ones of the groups of data points relate to scatter from respective different parts of the article.

2. The removable cartridge of claim 1, wherein the detector arrangement comprises a plurality of photodetectors, each photodetector for detecting a respective signal obtained when the coherent beam scatters from different parts of the article in the reading volume.

3. The removable cartridge of claim 1, wherein the removable cartridge further comprises a data acquisition and processing unit for determining a signature of the article based upon an intrinsic property of the article from the set of groups of data points.

4. The removable cartridge of claim 1, wherein the removable cartridge comprises a radio transmitter for transmitting information encoding values of the data points to a receiver located externally to the removable cartridge.

5. The removable cartridge of claim 1, wherein the removable cartridge is configured to substitute for a removable printer cartridge in a printer.

6. The removable cartridge of claim 5, wherein the removable printer cartridge is an inkjet printer cartridge.

7. The removable cartridge of claim 6, wherein the inkjet printer cartridge is a colour inkjet cartridge.

8. The removable cartridge of claim 5, wherein the removable cartridge is further operable to print on an article when the printer is operated.

9. A reprographics device adapted to operate with the removable cartridge of claim 1.

10. The reprographics device of claim 9, wherein the reprographics device is a printer.

11. A system for identifying an article from a signature based upon an intrinsic characteristic of the article, the system comprising:
a signature determination unit comprising the removable cartridge of claim 1, wherein the signature determination unit is operable to determine a signature from the data points generated by operating the signature scanning unit of the removable cartridge; and
a comparison unit operable to compare the determined signature to a stored signature.

12. The system of claim 11, wherein the comparison unit is further operable to split the determined signature into blocks of contiguous data and to perform a comparison operation between each block and respective blocks of the stored signature.

13. A method for identifying an article from a signature based upon an intrinsic characteristic of the article, the method comprising:
determining a signature from data points generated by operating a signature scanning unit provided in a removable cartridge of a reprographics device; and
comparing the determined signature to a stored signature.

14. The method of claim 13, further comprising:
splitting the determined signature into blocks of contiguous data; and
performing a comparison operation between each block and respective blocks of the stored signature.

15. A computer program product for controlling the operation of the removable cartridge of claim 1, wherein the computer program product comprises code that is executable to control:
activation of the coherent source of the signature scanning unit; and
collection of the set comprising groups of data points by the detector arrangement.

16. The computer program product of claim 15, further comprising code that is executable to manage the transfer of the set comprising groups of data points from the cartridge to a processing unit located external to the removable cartridge.

17. The computer program product of claim 16, wherein the transfer of the set comprising groups of data points from the cartridge to a processing unit located external to the removable cartridge is made via an interface provided for communicating with the reprographics unit.
